(19) United States
(12) Patent Application Publication
(10) Pub. No.: US 2007/0227639 A1
(43) Pub. Date: Oct. 4, 2007

(54) Vehicular wheel and method of forming the same

(76) Inventor: Juan J. Cortes, Riverside, CA (US)

Correspondence Address: Kit M Stetina, Esq.;STETINA BRUNDA GARRED & BRUCKER, 75 Enterprise, Suite 250, Aliso Viejo, CA, 92656, US

(21) Appl. No.: 11/396,885

(22) Filed: Apr. 3, 2006

(51) Int. Cl. B60C 25/00

(52) U.S. Cl. 152/396

(57) ABSTRACT

A wheel assembly comprises an outboard flange and an inboard portion. The inboard portion includes an inboard flange that is integrally formed with a center portion. The outboard flange may be joined to the inboard portion at a circumferential wheel joint. Welding and/or fasteners may be utilized in order to join the outboard flange to the inboard portion at the wheel joint. A retention member may optionally be included along the wheel joint in order to axially outwardly bias the fasteners to prevent inadvertent loosening of the fastener during the life of the wheel assembly.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to wheels or rims for motor vehicles and, more particularly, to a uniquely configured two-piece wheel assembly comprising an outboard flange that is assembled to an inboard portion to achieve a modular vehicular wheel system to allow for personalized styling of the wheel assembly to match a driver's tastes.

In the automotive accessory industry, aftermarket wheels are typically purchased in order to achieve a specific look or styling that is distinguished from the factory-styled wheels that are supplied with a new automobile, truck, van, etc. Drivers who personalize their vehicles with aftermarket wheels typically seek a unique wheel geometry and/or unique wheel finish than that which is available with factory-styled wheels.

One popular change which many drivers seek in aftermarket wheels is a larger diameter wheel and a greater width and offset than that which is available with factory-styled wheels. Along with the larger wheel diameter and greater width is a desire by many drivers to also upgrade the tires to a lower profile and higher performance tire in order to complete the overall look of the wheel/tire assembly. Although an increase in wheel diameter typically affects the accuracy of odometer and speedometer readings, equipping the larger diameter wheel with a lower profile tire having a shorter side wall reduces the impact on odometer/speedometer accuracy. Furthermore, low profile tires typically improve steering response and lateral stability of the vehicle in addition to increasing the visual appeal of the vehicle.

The prior art includes several attempts by manufacturers to provide aftermarket wheels that allow for versatility in wheel styling and sizing. For example, one-piece wheels are well known in the art and typically comprise a cast wheel such as an aluminum alloy wheel. As is known in the art, the casting process comprises pouring of molten metal such as aluminum into a mold to form the wheel. Ideally, the molten metal flows to all regions of the mold under the force of gravity or under a relatively low pressure in order to assist the movement or flow of the molten metal into extreme areas of the mold. Unfortunately, the casting process for manufacturing one-piece wheels suffers from several drawbacks that result in a relatively high-weight wheel.

In addition, the casting of one-piece wheels presents problems in realizing the complete formation of certain features in extreme areas of the mold. As a result, the wheel cross section must typically be locally increased in order to allow for complete formation of certain wheel features. A high-weight is the unfortunate result of the gravity-assisted one-piece casting process as increased cross sectional area is required in order to pack the molten metal into the extreme mold areas. Low pressure casting may result in a wheel that is generally lighter weight and stronger than a gravity cast wheel but such wheel typically suffers from an increase in fabrication cost.

One-piece wheels may also be formed using the casting process in combination with a post-processing spinning or rolling technology. In general, such spinning process includes the use of steel rollers to apply pressure and heat to certain areas of the wheel in order to increase the strength thereof. A further increase in strength of the wheel is achievable using a forging process instead of a casting process. During forging, a solid billet of metal is forced under extreme pressure through the use of forging dyes in order to produce a wheel that is relatively dense and has relatively high strength and is therefore lightweight. Unfortunately, the high costs of tooling and equipment for the forging process results in a wheel that is of exorbitant price for the automotive aftermarket industry.

An additional drawback associated with one-piece wheels is associated with the difficulty in applying a uniform finish or coating to the wheel after the wheel formation process. For example, in chrome plating, it is typically necessary to submerge the complete wheel assembly into a container having an appropriate solution and connecting the wheel to an electric circuit such that a layer of chrome may be electroplated onto the wheel. Because of the required size of the container and electroplating equipment, the chrome plating process for a one-piece wheel is relatively expensive as compared to the cost for chrome plating or electroplating a wheel that is separable into individual components.

In an attempt to overcome the problems associated with manufacturing and processing of one-piece wheels, manufacturers of aftermarket wheels have developed a two-piece wheel assembly comprising a center portion and a rim portion. The center and rim portions may be assembled together in order to produce the finished wheel. Because of the reduced overall size of the individual components (i.e., the center portion and the rim), various manufacturing methods may be more conveniently utilized. For example, the center portion may be produced by casting, machining and/or forging.

The rim sections may be additionally produced by spinning or rolling of the rim section in order to achieve improved weight and strength characteristics similar to that which is available using forging technology. Unfortunately, due to the high development and production costs associated with forging and rolling or spinning, conventional two-piece wheel assemblies are generally of relatively high cost. Furthermore, the production of the center portion and rim section using the forging and/or spinning or rolling technologies is relatively time-consuming.

Also included in the prior art is a three-piece wheel construction comprising a center portion and a pair of rim sections that are assembled utilizing fasteners such as bolts, rivets or press-fit pins and/or a welding process. The location of the joint between the rim sections and the center portion is referred to as a wheel joint and normally requires the application of a sealant therearound in order to provide an airtight seal such that tubeless tires may be mounted on the wheel. The rim sections and center section may be produced using the same technologies described above for the one-piece and two-piece wheels.

Advantageously, three-piece wheels tend to provide greater versatility and modularity in achieving a desired wheel geometry (i.e., wheel width, offset, etc.) as well as greater versatility in the available finished for the rim sections and center portion. For example, chrome plating may be applied to the rim sections while the center portion may be painted or powder coated. Unfortunately, despite the increased versatility in finish and wheel geometry that is achievable using three-piece wheels, the increase in part quantity results in a associated increase in development and production costs for three-piece wheels limits the marketability of such three-piece wheels.

As can be seen, there exists a need in the art for a wheel assembly that provides modularity between the rim section and the center section to allow for a variety of finishes that may be economically applied to the respective components. Furthermore, there exists a need in the art for a wheel assembly that allows for wide versatility in wheel geometries such that a wide range of wheel diameters, offsets and rim widths is available. Finally, there exists a need in the art for a wheel assembly that is economically producible and which may be produced in a time-efficient manner.

### BRIEF SUMMARY

The present invention addresses the above referenced deficiencies associated with prior art wheel assemblies. More specifically, the present invention is a wheel assembly that is economically produced by interconnecting an inboard portion to an outboard flange. The inboard portion to an outboard flange are separately formed prior to joining.

The inboard portion is comprised of an inboard flange which is integrally formed with a center portion. The outboard flange is connected to the inboard portion at a circumferential wheel joint in order to form the wheel assembly. The center portion may include various design configurations including spoked configuration such as a five-spoke design. Each of the spokes preferably extends radially outwardly toward the inboard flange from a center bore of the center portion. Non-spoke configurations of the center portion may also be formed in the wheel assembly.

The center portion includes a bolt or lug pattern which allows for provides a means for mounting of the wheel assembly to a hub of the motor vehicle. The center portion may include a mounting surface disposed on an inboard side of the wheel assembly for mounting the wheel assembly to the hub. The mounting surface bears against the hub and the wheel assembly is securely fastened thereto using a plurality of lug nuts or lug bolts. The inboard flange has a generally band-shaped configuration and is comprised of a circumferential band section having a radially outwardly directed inboard lip.

Opposite the inboard lip is the inboard bead seat against which one of opposing side walls of the tire may bear when the tire is mounted on the wheel assembly and is inflated. The inboard flange may further include a slightly ramped circumferential surface disposed adjacent the inboard bead seat to enhance sealing of the tire bead. The tire bead is specifically configured to provide an essentially leak-proof seal with the wheel assembly.

The inboard portion may further include an inboard ring extending radially outwardly about a periphery of the inboard portion. The inboard ring provides a mechanism by which the inboard portion and outboard flange may be interconnected. In this regard, the inboard ring has a generally annular configuration and may further include a plurality of axial bores extending therethrough at a desired angular spacing about the wheel joint.

The outboard flange is preferably formed as a unitary structure and is bolted to the inboard portion to form the wheel assembly. The outboard flange comprises an outboard lip and an outboard bead seat similar to the bead seat described above for the inboard flange. The outboard flange further includes a circumferential band section that extends laterally from the outboard lip to an outboard ring. The outboard ring is formed as an annular shape and is configured to mate with the inboard ring. In this regard, the outboard ring includes a plurality of bores formed therethrough which are preferably equal in spacing and number to the bores formed in the inboard ring.

The wheel joint may include a plurality of fasteners which are specifically configured to extend through the bores in the inboard and outboard rings for interconnection of the outboard flange to the inboard portion. The fasteners may be comprised of a nut and bolt combination or, alternatively, may be comprised of threaded fasteners that are threadably engaged to tapped holes in the inboard portion. An undercut may be provided circumferentially about the wheel joint within the inboard portion to provide a flat surface against which the nuts may bear.

Sealant may be provided over each of the fasteners (i.e., nut and bolt combinations) in the undercut area in order to protect the fastener against various forms of debris and fluid (i.e., brake dust, road salt, moisture, gravel, dirt, rocks and other harmful elements). Such sealant may be comprised of a silicone sealant which is cured as a layer over each of the fasteners in the area of the nut and bolt. Alternatively, the outboard flange may be joined to the inboard portion by utilizing various forms of welding.

An arcuately shaped retention member may be installed under the fastener heads such that the fastener are biased axially outwardly. In this regard, the retention member is configured to function as a conventional lock washer. The retention member may be shaped as a complete 360° ring which is secured to the wheel assembly by the fastener heads. The retention member may include a draft angle formed on an inner surface of the retention member in order to provide the desired biasing force when the fasteners are tightened.

A tape overlay may be provided circumferentially about the wheel joint. The tape overlay is preferably of an elastomeric or stretchable material and is preferably configured to span laterally from each side of the wheel joint in order to provide a predetermined amount of overlap sufficient to effectively seal the wheel joint. In this manner, tire pressure may be maintained when the tire is mounted on the wheel assembly.

Various finishes may be applied according to a driver's tastes due to the separate manufacturing of the inboard portion and the outboard flange. For example, the outboard flange, inboard portion and retention member may each be provided with different finishes which may include paint, powder coating, anodizing and various chroming and texturing finishes. In addition, due to the individual manufacturing operations for the outboard flange and the inboard portion, customized widths, offsets and wheel diameters may be provided with the wheel assembly of the present invention.

For example, the wheel assembly provides an economically-available rim that may be suitable for mounting of low profile tires that have a relatively short sidewall. The wheel assembly of the present invention provides the ability to achieve an infinite variety of widths of the outboard flange in combination with the inboard portion. Furthermore, the differing widths provide a means for achieving a customized spacing between left and right wheel on the front and back of the motor vehicle.

### BRIEF DESCRIPTION OF THE DRAWINGS

These as well as other features of the present invention will become more apparent upon reference to the drawings wherein:

FIG. 1 is a perspective view of a two-piece wheel assembly of the present invention and illustrating an outboard flange and an inboard portion that make-up the wheel assembly;

FIG. 2 is a side view of the wheel assembly illustrating a plurality of fasteners for interconnecting the outboard flange to the inboard portion;

FIG. 3 is a section view of the wheel assembly taken along lines 3-3 of FIG. 2 and illustrating the geometric parameters of the wheel assembly and their affect on offset “E” of the wheel centerline from the mounting surface of the wheel assembly;

FIG. 4 is an exploded perspective view of the wheel assembly illustrating the outboard flange, inboard portion comprising an inboard flange and a center portion, and a retention member or ring;

FIG. 5 is a sectional view of the retention member taken along line 5-5 of FIG. 4 and illustrating a draft angle formed on an inner surface of the retention member;

FIG. 6a is a partial cross-sectional view of a wheel joint for interconnecting the outboard flange to the inboard portion wherein the fasteners are configured as a nut and bolt combination and further including the retention member disposed underneath the fastener head;

FIG. 6b is a partial cross-sectional view of the wheel joint illustrating the fastener installed in a tapped hole formed in the inboard flange of the wheel assembly;

FIG. 6c is a partial cross-sectional view similar to that which is shown in FIG. 6b but omitting the retention member; and

FIG. 7 is a chart including preferred dimensional parameters corresponding to FIG. 3 and listing flange width “F” and bolt pattern diameter “G” variations.

### DETAILED DESCRIPTION

Referring now to the drawings wherein the showings are for purposes of illustrating various aspects of the invention and not for purposes of limiting the same, shown in the figures is a wheel assembly 10 which, in its broadest sense, comprises an outboard flange 12 secured to an inboard portion 20. As can be seen in the figures, the inboard portion 20 is comprised of an inboard flange 22 integrally formed with a center portion 54. The outboard flange 12 is connected to the inboard portion 20 at a circumferential wheel joint 30 in order to form the wheel assembly 10. As can be seen in the figures, the inboard flange 22 and center portion 54 are integrally formed as a unitary structure.

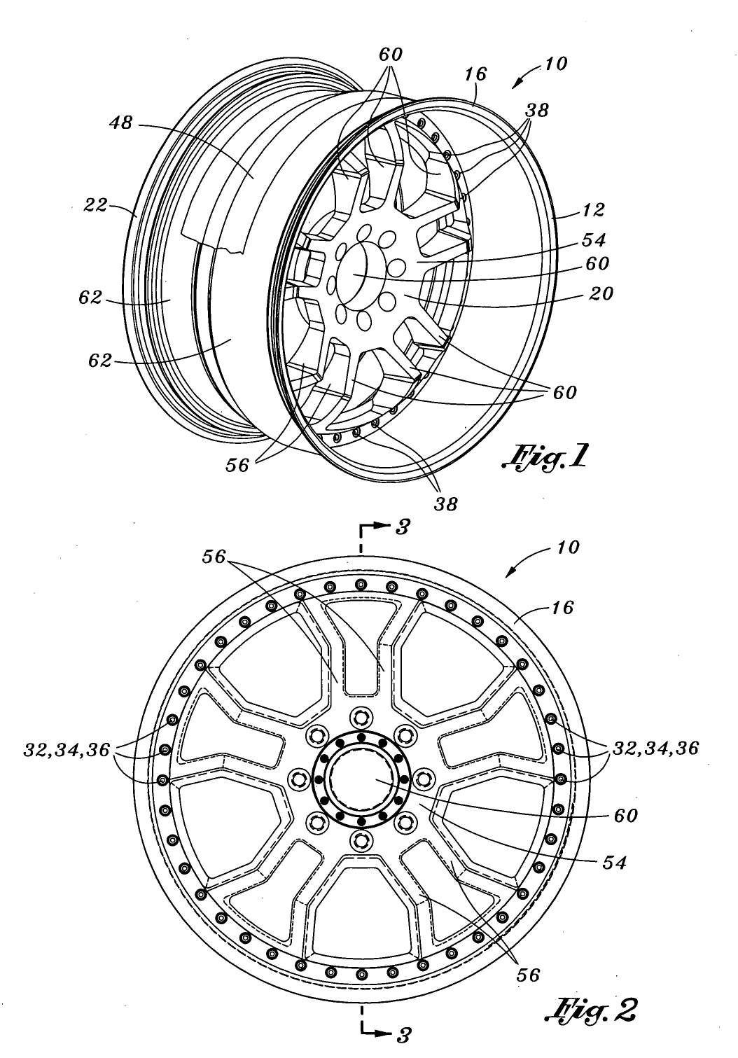

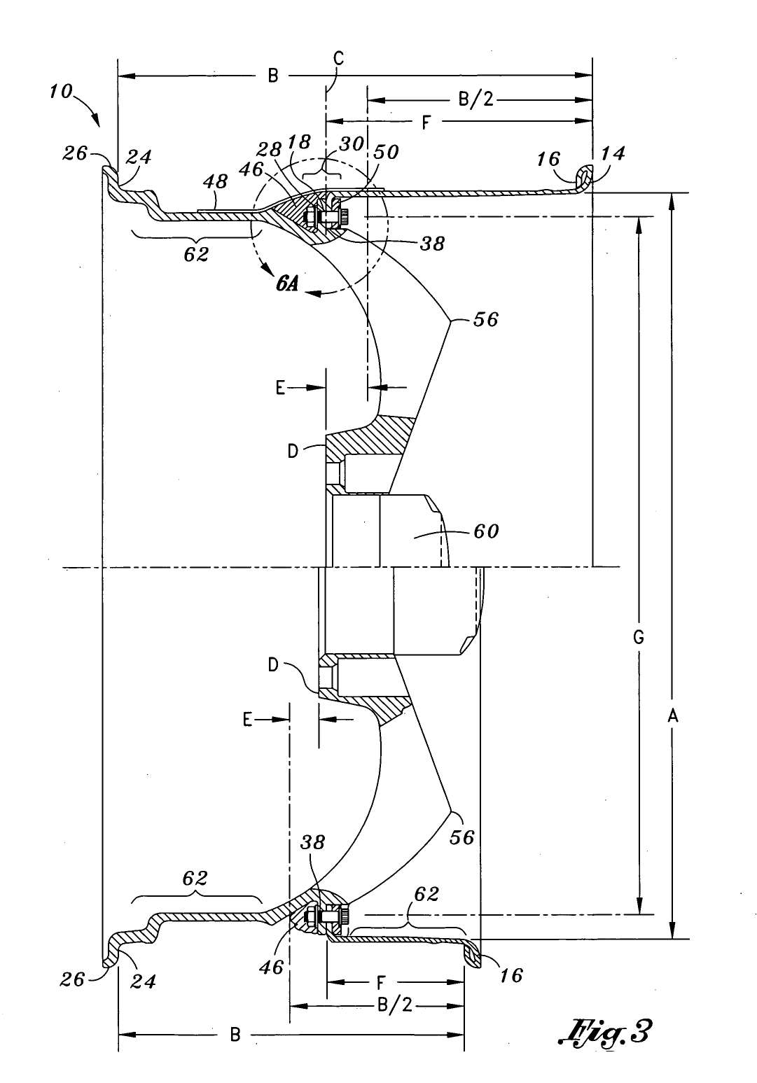

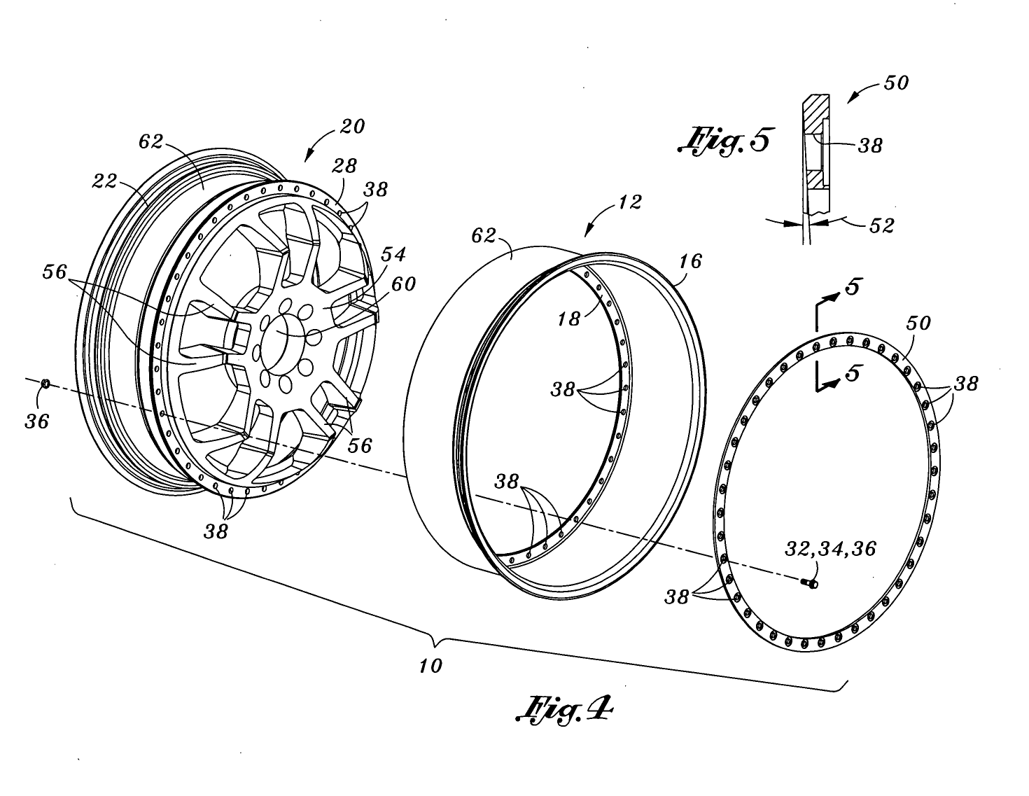

As best seen in FIGS. 1-4, the center portion 54 may include a spoked configuration but may optionally include any number of design configurations. In this regard, the wheel assembly may include a general five-spoke design wherein each spoke 56 may comprise a single member extending from a center bore 60 of the center portion 54 radially outwardly toward the inboard flange 22 of the inboard portion 20. Alternatively, as is shown in FIGS. 1, 2 and 4, each of the spokes 56 may be comprised of a plurality of spoke 56 elements which extend radially from the center bore 60 of the wheel assembly 10 toward the inboard flange 22 for interconnection therebetween.

Although a five-spoke design is shown in the figures, any number of spokes 56 or alternative interconnecting members or designs may be provided to connect the interior of the center portion 54 to the inboard flange 22. For example, a six-spoke or a cross-spoke configuration may be integrated into the center portion 54. For configurations of the wheel assembly 10 wherein the center portion 54 includes spokes 56, each of the spokes 56 includes an opening 58 which serves to angularly space the spokes 56 apart. Alternatively, the center portion 54 may include a multi-spoked configuration having equiangularly spaced spokes 56 extending around the center portion 54. Non-spoke configurations of the center portion 54 are also contemplated.

The center portion 54 of the wheel configuration may include a bolt or lug pattern to allow for mounting of the wheel assembly 10 to a hub of the motor vehicle. As is well known in the art, lug bores may be provided in four-lug, five-lug, six-lug and eight-lug patterns although any lug pattern may be provided in the center portion 54 to accommodate the particular motor vehicle to which the wheel assembly 10 is to be mounted. The interface between the center portion 54 and the hub is the mounting surface D disposed on an inboard side of the wheel assembly 10. As can be seen in FIG. 3, the mounting surface D bears against the hub such that the wheel assembly 10 may be securely fastened against the hub using a plurality of lug nuts extending through each of the lug bores.

As will be described in greater detail below, the overall geometry of the wheel assembly 10 is preferably such that adequate clearance is provided with respect to nearby components of the motor vehicle. For example, clearance is preferably provided between the tire and the wheel well of the motor vehicle as well as with frame members, brake calipers and other components that the wheel assembly 10 must clear. Such clearance is typically accommodated by calculating a desired amount of offset E between a wheel centerline and the mounting surface D. As is shown in FIG. 3, the wheel centerline is designated as B/2 and is defined as being located midway between a rim width B of the wheel assembly 10 in the assembled state.

In this regard, the offset E may be a positive offset E or a negative offset E in order to achieve dual functions of providing adequate clearance with nearby components of the motor vehicle as well as to achieve the desired aesthetics and provide the desired handling qualities for the automobile. For example, in order to achieve a desired styling look of the vehicle, aftermarket automotive wheels may be selected to provide a negative offset E of the wheel assembly 10 wherein the mounting surface D of the wheel assembly 10 is located generally inboard of the rim centerline C. Conversely, a positive offset E may occasionally be desired wherein the mounting surface D is located outboard of the rim centerline C such that the entire wheel assembly 10 is biased toward an axially inward location.

As can be seen in FIG. 3, the inboard flange 22 has a generally band-shaped configuration and is comprised of a circumferential band section 62 having a radially outwardly directed inboard lip 26. Opposite the inboard lip 26 is the inboard bead seat 24 against which one of opposing side walls of a tire may bear when the tire is fully inflated. Regarding the inboard flange 22, an axially outwardly-turned extension may be seen formed thereon which is specifically configured to engage a complementary circumferential mating feature of the tire bead. The inboard flange 22 may further include a slightly ramped circumferential surface disposed adjacent to the inboard bead seat 24 in order to enhance sealing of the tire bead to the inboard bead seat 24.

The inboard flange 22 may further include a circumferential safety hump formed adjacent to the inboard bead seat 24 and which is provided to retain the tire bead during mounting of the tire. In this regard, each of the opposing side walls of the tire includes a tire bead extending around a periphery thereof. The tire bead is specifically configured to ride up over the safety hump when the tire is inflated until the tire bead bears against the inboard and outboard flanges 22, 12 of the wheel assembly 10. Furthermore, the tire bead ideally provides an essentially leak-proof seal with the inboard and outboard bead seats 24, 14 in order to maintain pressure within the tire.

The inboard portion 20 may further include an inboard ring 28 which extends radially outwardly about a periphery thereof. The inboard ring 28 is provided such that the inboard portion 20 and outboard flange 12 may be connected together. The inboard ring 28 is generally formed at an intersection of the inboard flange 22 with the center portion 54. The inboard ring 28 may have an annular configuration and may further include a plurality of bores 38 extending axially therethrough although the bores 38 may be formed at any angular spacing about the wheel joint 30.

As was earlier mentioned, the inboard portion 20 comprising the inboard flange 22 and center portion 54 may be formed using a variety of manufacturing processes including casting, machining, forging followed by post-processing machining and other suitable manufacturing processes in order to achieve the desired features. Regarding materials from which the inboard portion 20 may be formed, it is contemplated that any material having suitable strength and weight characteristics may be utilized. Aluminum alloy may be a preferable material from which to fabricate the inboard portion 20 due to the superior mechanical properties of such alloy metals as compared to ferrous metals. Furthermore, alloy metals typically exhibit superior machinability and post-processing characteristics as compared to ferrous metals. The alloy may comprise other suitable compositions including, but not limited to, steel, magnesium and titanium.

The outboard flange 12 which may be fabricated in a similar manner to that described above for manufacturing the inboard portion 20 and may include the use of casting, forging, spin-forming, roll-forming as well as machining and/or any combination thereof. The outboard flange 12 is preferably formed as a unitary structure which is fastened to the inboard portion 20 to form the wheel assembly 10. As shown in the figures, the outboard flange 12 comprises an outboard lip 16 and an outboard bead seat 14 similar to that which is described above for the inboard flange 22. A circumferential band section 62 extends from the outboard lip 16 to an outboard ring 18 which extends generally radially inwardly about a periphery of the outboard flange 12.

In this regard, the outboard ring 18 is formed as an annular shape and may include a plurality of bores 38 formed therethrough which may be equiangularly spaced about the wheel joint 30. The bores 38 in the outboard ring 18 are preferably provided in equal number and spacing to the bores 38 in the inboard ring 28. A safety hump may be formed circumferentially on the band section 62 of the outboard flange 12 in a manner similar to that described for the safety hump of the inboard flange 22. The outboard bead seat 14 is preferably configured complementary to the tire beads such that a sealing fit may be provided therebetween during inflation of the tire.

The wheel joint 30 may further include a plurality of fasteners 32 which are specifically configured to extend through the bores 38 in the inboard and outboard rings 28, 18 in order to interconnect the outboard flange 12 to the inboard portion 20, thus forming the wheel assembly 10. As was earlier mentioned, the fasteners 32 are preferably equiangularly spaced about the wheel joint 30 but may be provided in any spacing and in any number. The fasteners 32 may be in any suitable form to securely connect the outboard flange 12 to the inboard portion 20. In this regard, the fasteners 32 may comprise a bolt and nut 36 combination wherein the bolt has a bolt head which may be disposed in an outboard direction of the wheel assembly 10. The nut engages threads that are formed on the fastener 32 in the conventional manner in order to connect the inboard and outboard rings 28, 18.

In order to facilitate the threadable engagement of the nut to the bolt, an undercut 42 may be provided within the inboard portion 20 and extending circumferentially about the wheel joint 30. The undercut 42 is specifically adapted to provide clearance for the nut as well as to provide a surface against which the nut may bear in order to clamp the inboard and outboard rings 28, 18 together. Although the undercut 42 is shown as having a generally V-shaped configuration running circumferentially about the inboard portion 20, it is contemplated that the undercut 42 may be locally disposed adjacent each one of the bores 38 as a series of pockets in order to provide a local area for securing the nut to the bolt.

Sealant 46 may be provided over the nut in the area of the undercut 42 in order to protect the nut and/or bolt combination against brake dust, road salt, moisture, debris such as gravel, dirt, rocks, tar, oil and other harmful fluids or debris. It is contemplated that the sealant 46 is an elastomeric material such as silicone sealant 46 which may be room temperature curable (RTV) sealant 46 or other suitable sealant. Providing such a layer of sealant 46 over each of the fasteners 32 in the area of the undercut 42 may minimize corrosion, rusting, and damage to the fasteners 32. In this regard, any suitable sealant 46 materials or component may be utilized in order to protect the fastener 32 (i.e., nut and bolt 36) from the elements or from harmful fluids or debris.

As an alternative to joining the outboard flange 12 to the inboard portion 20, various forms of welding may be utilized in order to interconnect such components to form the wheel joint 30. The welding may comprise a series of spot welds at strategic locations about the circumference of the wheel joint 30. The welding may also be formed as a continuous weld bead which additionally provides the advantage of forming an airtight seal between the outboard flange 12 and the inboard portion 20. For such a welded joint, elastomeric material or sealant 46 may additionally be layered across the wheel joint 30 adjacent to the weld. The welding may be a conventional weld connection or it may be formed by friction stir welding or any other suitable form of welding for rigidly interconnecting the outboard flange 12 to the inboard portion 20.

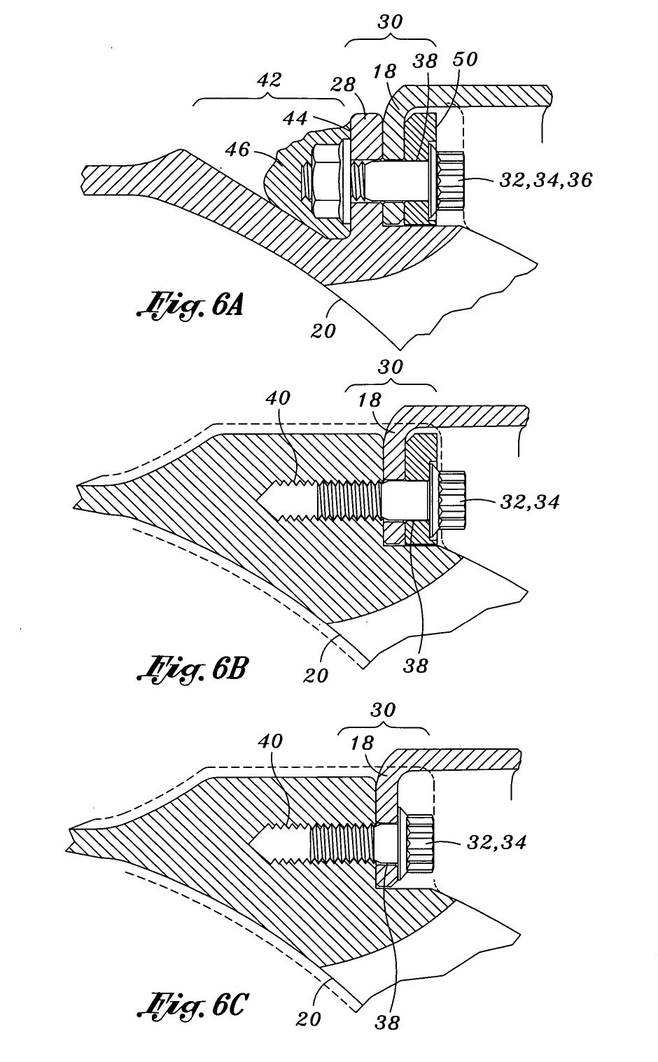

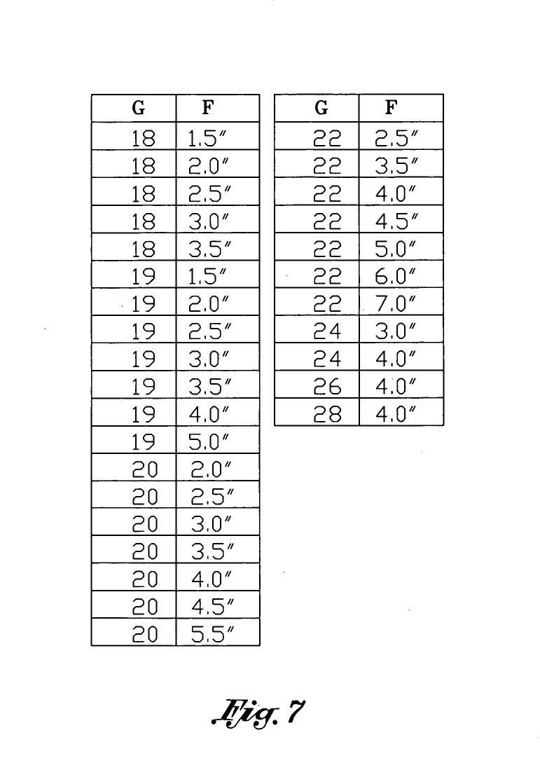

Referring now to FIGS. 6b and 6c, shown is the inboard portion 20 omitting the undercut 42 running circumferentially about the wheel joint 30 and instead including a plurality of tapped holes 40 equal in number and spacing to the bores 38 formed in the outboard ring 18. The tapped holes 40 are preferably sized and configured to threadably receive fasteners 32 which are extended through the bores 38 formed in the outboard ring 18 in order to secure the outboard flange 12 to the inboard portion 20.

Optionally, the wheel assembly 10 may include an arcuately shaped retention member 50 for installation with the fasteners 32 wherein the retention member 50 is secured underneath the fasteners heads 34 such that the retention member 50 is captured between the fastener head 34 and the inboard ring 28. Preferably, the retention member 50 is configured to provide a biasing effect to the fastener 32 in an axially outward direction and, in this regard, may function similar to a conventional lock washer or a Bellville washer. Although the wheel assembly 10 may include a plurality of the arcuately shaped retention members 50 with each retention member 50 being inserted under any number (e.g., three or four) of fasteners 32, the retention member 50 may alternatively be shaped as a complete 360° ring which is disposed against the outboard ring 18 and is secured thereagainst when the fasteners 32 are threadably engaged.

Referring now to FIG. 5, in order to provide the desired biasing force, the retention member 50 is preferably formed with an inner surface 44 having a draft angle 52 incorporated thereinto. The draft angle 52 may be formed by machining or by any other suitable forming means such as by stretch forming or other forming or machining processes. In order to provide the desired bias force, it is contemplated that the draft angle 52 has a value of up to about 5° relative to a plane defined by an outer perimeter of the retention member 50. However, the draft angle 52 may preferably be about 3° although any suitable angle may be incorporated for the draft angle 52. It should be noted that the retention member(s) 50 may be optionally included and are not necessarily a component of the wheel assembly 10. In this regard, it is contemplated that each of the fasteners 32 may include a suitable lock washer or locking mechanism in order to prevent inadvertent loosening of the fastener 32.

Although threaded fasteners 32 have been discussed above and may be configured as a nut and bolt 36 combination or as a threaded stud engaging tapped holes 40 formed in the inboard portion 20, it should also be noted that the fasteners 32 may be provided as press-fit pins, Hi-loks, rivets or any other suitable connecting mechanism. Each of such connecting elements of fasteners 32 may be axially oriented with respect to the wheel assembly 10. Regardless of their configuration, the fasteners 32 are preferably configured to mechanically secure the outboard flange 12 to the inboard portion 20 while simultaneously preventing any relative radial motion between the outboard flange 12 and the inboard portion 20.

As can be seen in FIGS. 1 and 3, in order to provide an airtight seal for a tire mounted on the wheel assembly 10, it is contemplated that a tape overlay 48 may be provided over the wheel joint 30′. The tape overlay 48 is preferably of an elastomeric material and is preferably of circumferential configuration in order to extend around the entire wheel joint 30. The tape overlay 48 is preferably of a stretchable material and may be comprised of any suitable rubber, or polymeric compound and preferably has a width that extends axially from each side of the wheel joint 30 to provide a sufficient amount of overlap to effectively seal the wheel joint 30.

Various finishes may be applied to the outboard flange 12 and the inboard portion 20 as well as to the retention member 50. Such finishes may be selected based upon the desired look of the wheel assembly 10. For example, the outboard flange 12, inboard portion 20 and retention member 50 may be provided with finishes including, but not limited to, paint, powder coating, anodizing, alodining, various chroming processes, various texturing finishes such as that achievable with shot-blasting or glass peening. Such finishes may further include a clear coat on each of the above-mentioned finishes. In order to achieve a personalized appearance of the wheel assembly 10 to match the driver's tastes, it is contemplated that each of the separately-manufactured components (i.e., outboard flange 12, inboard portion 20, and retention member 50) may be provided with complementary types of finishes in order to achieve a customized look for the wheel assembly 10. In this regard, the above-described wheel assembly 10 provides an infinite number of choices in styling.

Furthermore, due to the customized widths of the outboard flange 12 in combination with the inboard flange 22, the wheel assembly 10 of the present invention provides an economically-available rim that may be suitable for mounting of wide and/or low profile tires having a relatively short sidewall which is a popular look in certain automotive customizing circles. In addition, the ability to select from different widths of the outboard flange 12 in combination with the inboard portion 20 allows for achieving a customized spacing between the left and right wheels on a motor vehicle relative to the spacing of the front wheels.

Typically, the factory wheel spacing for the front wheels of an automobile are typically different than that of the rear wheel. However, the present invention provides a means for achieving a wheel spacing that is different from that supplied by the factory. In this regard, the present invention provides an economical means for achieving different front and rear wheel spacings. Furthermore, the present invention allows for the use of a particular wheel assembly 10 configuration on an automobile or a truck by using the same inboard flange 22 width for the front and rear wheels while utilizing a different outboard flange 12 width. Additional mounting geometries may be achieved by changing the amount of offset E, as was earlier mentioned. Furthermore, the wheel assembly allows for a wide variety of wheel diameters A in personalizing a user's motor vehicle according to their individual tastes, as illustrated in the chart of FIG. 7.

The process for manufacturing and assembling the wheel assembly 10 will now be described with reference to the figures. The inboard portion 20 may be formed as a combination of the inboard flange 22 and central portion 54 and may be formed using any suitable manufacturing process including casting, machining, forging or any combination thereof. The outboard flange 12 may be formed in a similar manner but may additionally include a rolling process wherein a relatively straight section of material is rolled into a circumferential or annular configuration.

The rolled material may be joined at the ends such as by butt-welding or other suitable operation. The outboard lip 16 and outboard ring 18 may be formed on the outboard flange 12. Following the formation of the bores 38 in the outboard and inboard rings 18, 28 and/or tapping of the holes in the inboard portion 20, the outboard flange 12 and inboard portion 20 may be joined using suitable fasteners 32 with the option of including the retention member 50 to provide a biasing or locking mechanism. The retention member 50 may also provide greater options for enhancing the styling of the wheel assembly 10.

If the wheel assembly 10 is joined using the nut and bolt 36 combination as shown in FIG. 6a, the undercut 42 may be filled with sealant 46 in order to cover the fasteners 32 (i.e., nuts) for protection thereof from the elements and/or harmful fluids and/or debris. The tape overlay 48 may then be circumferentially applied about the wheel joint 30 in order to provide an airtight seal for the tire which is then mountable on the wheel assembly 10.

Additional modifications and improvements of the present invention may also be apparent to those of ordinary skill in the art. Thus, the particular combination of parts described and illustrated herein is intended to represent only certain embodiments of the present invention and is not intended to serve as limitations of alternative devices within the spirit and scope of the present invention.

What is claimed is:

1. A wheel assembly, comprising:
an outboard flange; and
an inboard portion having an inboard flange and a center portion integrally formed with the inboard flange;
wherein the outboard flange is connected to the inboard portion at a circumferential wheel joint.

2. The wheel assembly of claim 1 wherein the outboard flange is welded to the inboard portion along the wheel joint.

3. The wheel assembly of claim 1 wherein the wheel joint includes a plurality of fasteners interconnecting the outboard flange to the inboard portion.

4. The wheel assembly of claim 3 wherein the fasteners are equi-angularly spaced about the wheel joint.

5. The wheel assembly of claim 3 wherein the fasteners are threaded fasteners.

6. The wheel assembly of claim 5 wherein the inboard portion includes a plurality of tapped holes being sized and configured to threadably receive the threaded fasteners.

7. The wheel assembly of claim 5 wherein each of the threaded fasteners comprises a bolt and nut combination.

8. The wheel assembly of claim 3 wherein:
the inboard portion includes an inboard ring extending radially outwardly about a periphery thereof;
the outboard flange including an outboard ring extending radially inwardly about a periphery thereof and being configured to mate with the inboard ring;
the inboard and outboard rings having a plurality of bores extending therethrough and being sized and configured for receiving the fasteners.

9. The wheel assembly of claim 7 wherein the inboard portion includes an undercut extending at least partially around the wheel joint.

10. The wheel assembly of claim 9 wherein the undercut forms an inboard surface of the inboard ring against which the nuts may bear.

11. The wheel assembly of claim 5 further comprising sealant disposed within at least a portion of the undercut and at least partially covering the threaded fasteners.

12. The wheel assembly of claim 1 further comprising:
an arcuately-shaped retention member;
wherein:
each one of the fasteners includes a fastener head;
the retention member being captured between the fastener head and the inboard ring and being configured to bias the fastener head in an outboard direction.

13. The wheel assembly of claim 12 wherein the retention member is ring shaped.

14. The wheel assembly of claim 12 wherein the retention member is formed with an inner surface having a draft angle.

15. The wheel assembly of claim 13 wherein the draft angle is up to about five degrees.

16. The wheel assembly of claim 15 wherein the draft angle is about three degrees.

17. The wheel assembly of claim 1 further comprising a tape overlay at least partially covering the wheel joint.

18. The wheel assembly of claim 17 wherein the tape overlay layer is formed of elastomeric material.

19. The wheel assembly of claim 17 wherein the tape overlay layer is band-shaped and is sized and configured to extend about the circumferential wheel joint.

20. The wheel assembly of claim 1 wherein at least one of the outboard flange and inboard portion is formed by at least one of casting, spin forming, rolling, forging and machining.
